(19) United States
(12) Patent Application Publication
(10) Pub. No.: US 2010/0064004 A1
(43) Pub. Date: Mar. 11, 2010

(54) SYNCHRONIZING DOCUMENTS BY DESIGNATING A LOCAL SERVER

(75) Inventors: Kumar Ravi, Cedar Park, TX (US); Ayodeij Olasupo Olatunjii, Austin, TX (US); Ameet M. Paranjape, Cedar Park, TX (US)

Correspondence Address: IBM Corp. (GIG), c/o Garg Law Firm, PLLC, 4521 Copper Mountain Lane, Richardson, TX, 75082, US

(73) Assignee: INTERNATIONAL BUSINESS MACHINES CORPORATION, Armonk, NY (US)

(21) Appl. No.: 12/207,526

(22) Filed: Sep. 10, 2008

(51) Int. Cl. G06F 15/16

(52) U.S. Cl. 709/204

(57) ABSTRACT

A method, system, and computer usable program product for synchronizing documents by designating a local server are provided in the illustrative embodiments. A data network is formed that includes several data processing systems, each data processing system having a separate version of a document. A candidate data processing system is designated from the several data processing systems as a local server. Separate versions of the document are sent from the several data processing systems to the local server. The separate versions of the document are synchronized with a baseline version of the document to form a synchronized version of the document. The synchronized version of the document is returned to the several data processing systems. In addition, the data network may be formed if the data connectivity to an original server has been lost.

### BACKGROUND OF THE INVENTION

1. Field of the Invention

The present invention relates generally to an improved data processing system, and in particular, to a computer implemented method for managing documents in a data processing environment. Still more particularly, the present invention relates to a computer implemented method, system, and computer usable program code for synchronizing documents by designating a local server.

2. Description of the Related Art

In a data processing environment, several users may work on a common set of documents simultaneously. A set of documents is one or more documents in electronic form. Typically, each user retrieves a document from a server and makes a local copy of the document on a client data processing system of the user. Each user then manipulates the user's local copy of the document using the user's client data processing system.

As a result of several users making modifications to a common document, each user may create a different version of the same baseline version of the document. A baseline version of a document is a version of the document that is identical for each user when downloaded from the server, and one that each user subsequently modifies to create a modified version. A baseline version of a document may be a result of a previous collaboration by a group of users.

When several users collaborate by modifying a baseline version of a document independent of one another, each user's modified version has to be combined with the modified versions of other users in the team. Such combining may result in a new baseline version that the users can download for further collaboration later on.

Often, users download baseline version of a document, and upload modified versions of that document over a data network that interconnects one or more server data processing systems and one or more client data processing systems. In some data processing environments, the server may combine a user's modified version with the last baseline version of the document when the user connects with the server and uploads the user's modified version of the document. In other data processing environments, a server may wait until all users in a team have uploaded their respective modified versions and then combine all the modified versions to create a new baseline version of the document.

The process of combining the modified versions of a document into a new version is called synchronization. This process is also known as merging. Synchronization or merging includes combining the different versions together such that all modifications from all modified versions are available in a new baseline version as an achievement of the collaboration.

### SUMMARY OF THE INVENTION

The illustrative embodiments provide a method, system, and computer usable program product for synchronizing documents by designating a local server. A data network is formed that includes several data processing systems, each data processing system having a separate version of a document. A candidate data processing system is designated from the several data processing systems as a local server. Separate versions of the document are sent from the several data processing systems to the local server. The separate versions of the document are synchronized with a baseline version of the document to form a synchronized version of the document. The synchronized version of the document is returned to the several data processing systems.

In addition, a determination is made whether data connectivity to an original server has been lost. The data network is formed if the data connectivity to the original server has been lost. Additionally, the synchronized version of the document may be sent to an original server.

The candidate data processing system may be selected based on server designation parameters, which may include one or more of a number of changes proposed by a data processing system, amount of computing resources available at a data processing system, bandwidth available at a data processing system, data connectivity available from a data processing system to an original server, and a baseline version of a document. The designating may be in response to a server designation parameter being more favorable to the candidate data processing system as compared to another data processing system in the several data processing systems. All or less than all data processing systems in the several data processing systems may participate in selecting the candidate data processing system.

Furthermore, a determination may be made that a subset of the several data processing systems have lost data connectivity to an original server. A data processing system from which data connectivity to the original server remains available may be selected as the candidate data processing system. A further determination may be made that the local server is to act in a conduit mode. In such a case, the synchronizing may further include sending the separate versions of the document from the several data processing systems to the original server and receiving the synchronized version of the document from the original server.

A baseline version of a document to be synchronized may also be sent from the local server. The baseline version may be sent to a data processing system in the several the data processing systems that has a different version of the document.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of an example local network formed in accordance with an illustrative embodiment;

FIG. 4 depicts a block diagram of designating a server in an alternate manner in accordance with an illustrative embodiment;

FIG. 5 depicts a block diagram of a client data processing system negotiating example parameters for designating a local server in accordance with an illustrative embodiment;

FIG. 6 depicts a block diagram and a process of synchronizing documents using a designated local server in accordance with an illustrative embodiment;

FIG. 7 depicts a flowchart of a process for handling disruption in the document synchronization process in accordance with an illustrative embodiment;

FIG. 8 depicts a flowchart of a server designation process in accordance with an illustrative embodiment; and

FIG. 9 depicts a flowchart of a process for operating as a designated server in accordance with an illustrative embodiment.

### DETAILED DESCRIPTION OF THE PREFERRED EMBODIMENT

The illustrative embodiments recognize that the synchronization of a document is therefore largely dependent on the data network connectivity. In the event of a combination of client data processing systems, server data processing systems, and data network components becoming unavailable, the collaboration between the users may not be possible. Various users may be left with versions of a document that are different from one another. The illustrative embodiments recognize that the modifications contained in those versions cannot be successfully synchronized in a timely manner to create a new baseline version.

To address these and other problems related to synchronizing documents, the illustrative embodiments provide a method, system, and computer usable program product for synchronizing documents by designating a local server. A local server is a client data processing system that is designated to act as a server data processing system for other client data processing systems in a local network. A local network is a data network formed to interconnect two or more client data processing systems including the local server.

By using the illustrative embodiments, users may be able to continue collaborating even when data network connectivity to the server is lost from one or more user's client data processing system. The users may be able to form a local network among the users' client data processing systems and designate one of the client data processing systems as a local server by using the methods and processes described herein. The local server may then be able to synchronize the various modified versions of a document using the methods and processes described herein. Thus, the users may be able to collaborate even after having lost data network connectivity to the server that may have previously provided the synchronization functionality.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

The illustrative embodiments are described in some instances using particular data processing environments only as an example for the clarity of the description. The illustrative embodiments may be used in conjunction with other comparable or similarly purposed architectures for using virtualized real memory and managing virtual machines.

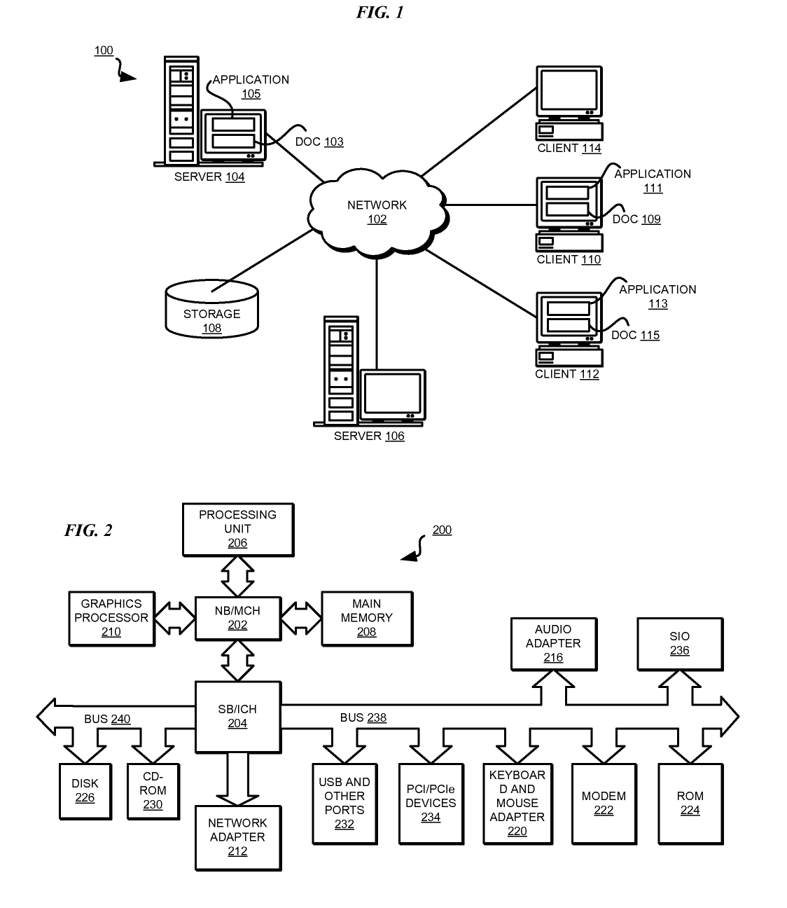

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108.

Software applications may execute on any computer in data processing environment 100. In the depicted example, server 104 includes application 105, which may be a software application that may perform the synchronization of documents. Server 104 may include or have access to document 103, which may be a baseline version of a document.

Client 110 may include application 111, which may represent one or more software applications executing on client 110. For example, one software application in application 111 may allow a user to manipulate a document and another may allow the user to form a local network with other clients. Client 110 may further include document 109, which may be a modified or unmodified version of a local copy of a baseline version of a document. Client 112 may include application 113, which may be similar to application 111. Client 112 may also include document 115, which may be another user's modified or unmodified version of a local copy of the baseline version of the same document as in client 110.

In addition, clients 110, 112, and 114 couple to network 102. Servers 104 and 106, storage units 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCl/PCIe devices 234 are coupled to south bridge and I/O controller hub 204 through bus 238. Hard disk drive (HDD) 226 and CD-ROM 230 are coupled to south bridge and I/O controller hub 204 through bus 240. PCl/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

With reference to FIG. 3, this figure depicts a block diagram of an example local network formed in accordance with an illustrative embodiment. Network 302 may be similar to network 102, server 304 similar to server 104, clients 310, 312, and 314 similar to clients 110, 112, and 114 respectively in FIG. 1.

Communication link 305 may connect server 304 to network 302. Similarly, communication links 311, 313, and 315 may connect clients 310, 312, and 314 respectively to network 302. Each of links 305, 311, 313, and 315 may be a wired data network connection or a wireless data communications link. Server 304 may provide clients 310, 312, and 314 a baseline version of a document, and perform the synchronization or merging of the various modified versions returned by clients 310, 312, and 314.

In certain situations in which the illustrative embodiments may be useful, one or more of communication links 305, 311, 313, and 315 may be disrupted. Such a disruption is depicted by showing a cross on the link in this figure. Note that while each of communication links 305, 311, 313, and 315 are shown as disrupted, any combination of these communication links may be disrupted in a given environment. Furthermore, server 304 may become unavailable even if all the communication links are otherwise functional.

Regardless of whether a communication link, server 304, or any combination thereof becomes unavailable, the users of clients 310, 312, and 314 may be unable to synchronize their respective modified documents with one another upon such disruption. Clients 310, 312, and 314, may be configured, in accordance with the illustrative embodiment, to configure local network 316 to facilitate data communication among clients 310, 312, and 314.

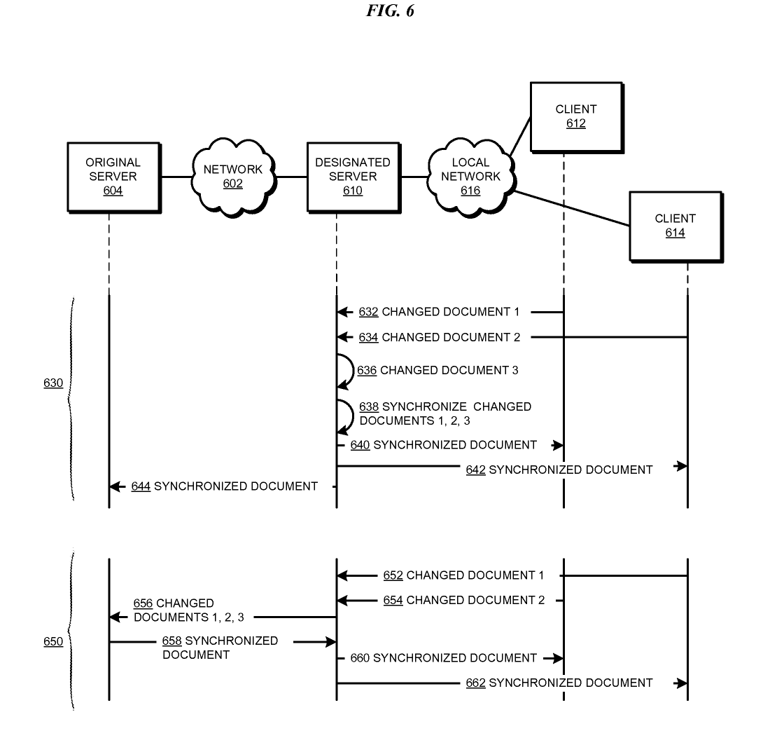

Having established local network 316, clients 310, 312, and 314 may be able to exchange data among themselves, without regard to server 304 that became unreachable due to the disruption. In accordance with the illustrative embodiment, clients 310, 312, and 314 may negotiate with each other to designate one of the clients to be elevated to the role of local server. The client that is elevated to the role of local server becomes the designated server and takes over the synchronization tasks. The synchronization process is described in detail with reference to FIG. 6.

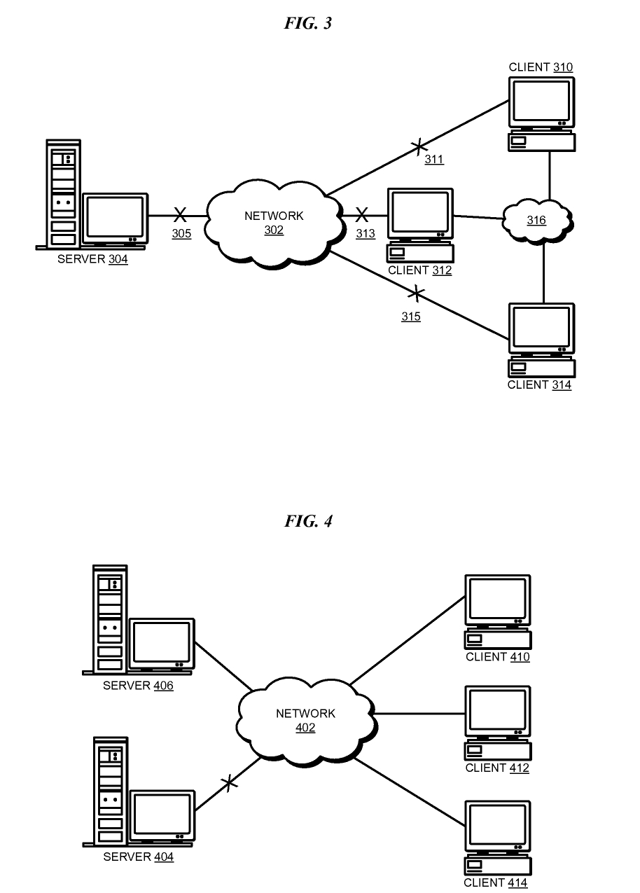

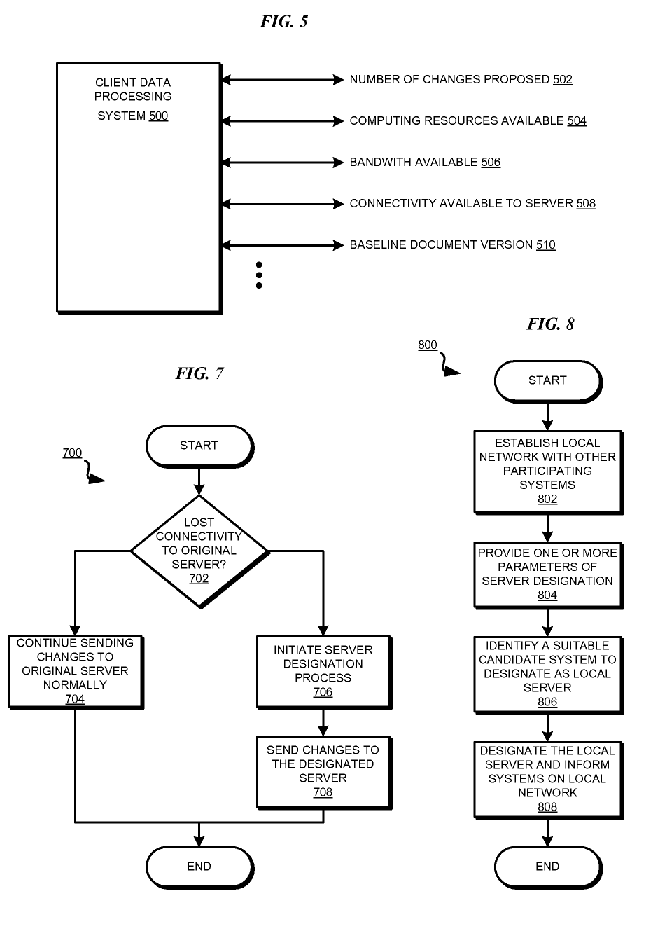

With reference to FIG. 4, this figure depicts a block diagram of designating a server in an alternate manner in accordance with an illustrative embodiment. Server 404 corresponds to server 304 in FIG. 3. Server 406 may be similar to server 106 in FIG. 1. Network 402, client 410, client 412, and client 414 correspond to network 302, client 310, client 312, and client 314 respectively in FIG. 3.

Under certain circumstances, clients 410, 412, and 414 may lose connectivity to server 404 in a manner that other data processing systems connected to network 402 remain available and visible to clients 410, 412, and 414. In such a case, clients 410, 412, and 414 may be able to negotiate among themselves and select another data processing system, such as server 406, to be the designated server for performing the synchronization. In essence, server 406 takes over the synchronization functions of server 404 and behaves like a local server as described with respect to FIG. 3.

Forming a local network, such as network 316 in FIG. 3, may be beneficial in some situations, whereas, selecting another data processing system on the existing network may be beneficial in other situations. For example, when a team of users travels to a customer site with their laptop computers, such as clients 310, 312, and 314 in FIG. 3, they may have no visibility to network 302 in FIG. 3, or any data processing system connected thereto. In such circumstances, the users may be able to utilize the illustrative embodiments by configuring a local network, such as local network 316 in FIG. 3.

As another example, the same team of users may go to a conference room to make a presentation, each user's laptop containing a variation of the presentation that they intend to make. The conference room may have limited connectivity to the corporate data network in that some servers may be reachable from the conference room network access point and others may not. In such a case, the users may be able to utilize the illustrative embodiments using the configuration described in FIG. 4.

Subsequent figures are described using the configuration of FIG. 3 as an example only for the clarity of the description. The illustrative embodiments according to those descriptions may be implemented in a configuration similar to the configuration shown in FIG. 4 or a variation thereof without departing from the scope of the illustrative embodiments.

With reference to FIG. 5, this figure depicts a block diagram of a client data processing system negotiating example parameters for designating a local server in accordance with an illustrative embodiment. Client data processing system 500 may be any of clients 310, 312, or 314 in FIG. 3.

Which data processing system connected to a local network, such as local network 316 in FIG. 3, is designated local server may depend on one or more parameters. These parameters are called server designation parameters. Server designation parameters are factors that influence the selection of a data processing system as a local server. For example, client data processing system 500 may inform other data processing systems on the local network the number of changes 502 it proposes to make to the baseline version of the document. In one embodiment, the data processing systems on the local network may elect that data processing system that proposes the most or least number of changes as a particular implementation may prefer.

As another example, client data processing system 500 may inform other data processing systems on the local network the amount of computing resources 504 such as memory, processing cycles, or storage space it has available. In one embodiment, the data processing systems on the local network may elect that data processing system that has the largest amount of specific resources available.

As another example, client data processing system 500 may inform other data processing systems on the local network, the bandwidth 506 available to it. Bandwidth 506 may be data communication bandwidth over the local network, or other data networks as may be utilized in particular implementations. In one embodiment, the data processing systems on the local network may elect that data processing system that has the largest bandwidth available.

As another example, client data processing system 500 may inform other data processing systems on the local network, whether connectivity 508 to the original server, such as server 304 in FIG. 3, is still available from it. In one embodiment, the data processing systems on the local network may elect that data processing system that may still be able to access the original server. One example advantage of designating the local server in this manner will be apparent from the description of FIG. 6.

As another example, client data processing system 500 may inform other data processing systems on the local network, the baseline version 510 on which it has applied changes. In one embodiment, the data processing systems on the local network may elect that data processing system that has the latest baseline version available. Such a parameter may be useful in designating the local server in circumstances where the data processing systems on the local network may be modifying different baseline versions, some baseline versions being older than others.

The example parameters described above are only described for the clarity of the description and are not limiting on the illustrative embodiments. A particular implementation may use additional or different parameters, or modify the example parameters described above, or use them in a different manner than as described, without departing from the scope of the illustrative embodiments.

With reference to FIG. 6, this figure depicts a block diagram and a process of synchronizing documents using a designated local server in accordance with an illustrative embodiment. Network 602 may correspond to network 302 in FIG. 3. Server 604 may correspond to server 304 in FIG. 3. Designated server 610 may correspond to client 310 in FIG. 3 when, as an example, client 310 is designated as the local server as described in FIG. 3. Clients 612 and 614 may correspond to clients 312 and 314 respectively in FIG. 3. Local network 616 may correspond to local network 316 in FIG. 3.

Designated server 610 may have been a client data processing system that other client data processing systems on local network 616 selected to elevate to a designated local server role. For example, data processing systems on local network 616 may have elected designated server 610 as the designated server considering that designated server 610 is still able to connect to network 602 as depicted in this figure, after clients 612 and 614 are no longer able to access network 602 or original server 604. Of course, other parameters may be utilized for the designation purpose as described with respect to FIG. 5.

In one configuration, designated server 610 may perform the synchronization and deliver a copy of the synchronized document to the original server at some point in time. The synchronization process in this configuration is depicted as process 630.

In process 630, a client, for example client 612, may send 632 its changed document, changed document 1, to designated server 610. Another client, if any, such as client 614, may send 634 its changed document, changed document 2, to designated server 610. Any number of changed documents may be delivered to designated server 610 in this manner.

Designated server 610 may retrieve 636 its own changed document, changed document 3. Designated server 610 may synchronize 638 the changed documents 1, 2, and 3, using any available algorithms for merging document changes. Designated server 610 may transmit 640 the synchronized document to client 612. Designated server 610 may transmit 642 the synchronized document to client 614. Designated server 610 may transmit 644 the synchronized document to original server 604 as well if possible at some time.

In another configuration, designated server 610 may act as a conduit for clients 612 and 614 while original server 604 performs the synchronization. Designated server 610 having remaining connectivity with original server 604 may deliver changed documents to original server 604 and deliver the synchronized document back to clients 612 and 614. The synchronization process in this alternate configuration is depicted as process 650.

In process 650, a client, for example client 614, may send 652 its changed document, changed document 1, to designated server 610. Another client, if any, such as client 614, may send 654 its changed document, changed document 2, to designated server 610. Any number of changed documents may be delivered to designated server 610 in this manner.

Designated server 610 may retrieve its own changed document, changed document 3. Designated server 610 may transmit 656 one or more changed documents from changed documents 1, 2, and 3 to original server 604 for synchronization. Original server 604 may synchronize the changed documents 1, 2, and 3, using any available algorithms for merging document changes. Original server 604 may transmit 658 the synchronized document to designated server 610. Designated server 610 may transmit 660 the synchronized document to client 612. Designated server 610 may transmit 662 the synchronized document to client 614. Of course, designated server 610 may itself retain a copy of the synchronized document.

Note that neither the order of send, retrieve, synchronize, nor transmit steps is limiting on the illustrative embodiments, nor are these steps exhaustive in processes 630 and 650. These steps may be performed in any order, and other similar or different steps inserted between these steps without departing from the scope of the illustrative embodiments. For example, in process 630, designated server 610 may perform the synchronize step after each send step, namely, after send 632, after send 634, as well as after retrieve 636. As another example, transmit 644 may occur before transmit 640 or 642 occurs. Many other variations of the processes depicted in FIG. 6 will be apparent from this disclosure.

With reference to FIG. 7, this figure depicts a flowchart of a process for handling disruption in the document synchronization process in accordance with an illustrative embodiment. Process 700 may be implemented in a client data processing system, such as any of clients 310, 312, or 314 in FIG. 3.

Process 700 begins by determining if the connectivity to an original server has been lost (step 702). If the connectivity to the original server is intact (“Yes” path of step 702), process 700 continues sending the changes to any document to the original server (step 704). Process 700 ends thereafter.

If, however, connectivity to the original server has been lost (“No” path of step 702), process 700 initiates a server designation process (step 706). The server designation process being initiated in step 706 is described in detail with respect to FIG. 8.

Once a local server has been designated, process 700 sends any changes to any documents to the designated server (step 708). Process 700 ends thereafter.

With reference to FIG. 8, this figure depicts a flowchart of a server designation process in accordance with an illustrative embodiment. Process 800 may be implemented in a client data processing system, such as any of clients 310, 312, or 314 in FIG. 3.

Process 800 begins by establishing a local network with other participating systems (step 802). Any number of data processing systems may participate in forming the local network. Process 800 provides one or more parameters of server designation to one or more of the other participating data processing systems (step 804).

Process 800 identifies a suitable candidate data processing system that may serve as local server (step 806). In certain circumstances, more than one candidate data processing systems may be identified and designated as backup local servers to one another.

Process 800 designates the identified data processing system as the local server and informs other participating data processing systems on the local network about the designation (step 808). Process 800 ends thereafter.

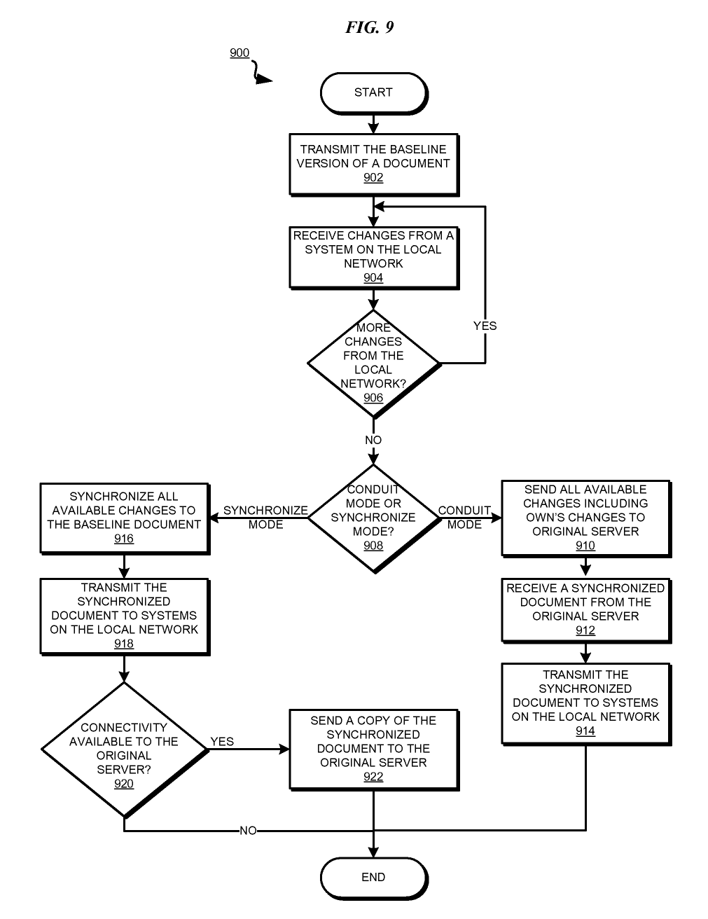

With reference to FIG. 9, this figure depicts a flowchart of a process for operating as a designated server in accordance with an illustrative embodiment. Process 900 may be implemented in a data processing system that can be designated as a local server, such as designated server 610 in FIG. 6.

Process 900 begins by transmitting a baseline version of a document to other data processing systems on a local network (step 902). Because various data processing systems on the local network may have different baseline versions, in performing 902, process 900 may seek to normalize the baseline version available on the data processing systems. In some implementations step 902 may be omitted.

Process 900 receives changes or changed documents from a data processing system on the local network (step 904). Process 900 determines if more systems are present on the local network that may provide changes (step 906). In step 906, process 900 may also set a time limit within which a system should provide its changes to process 900 or otherwise be deemed as non-existing or not having any changes to synchronize. If process 900 determines that more changes can be expected from other systems on the local network (“Yes” path of step 906), process 900 returns to step 904. If process 900 determines that no more systems may send changes or changed documents (“No” path of step 906), process 900 determines if the process 900 is to act in a synchronizing mode, as in process 630 in FIG. 6, or a conduit mode, as in process 650 in FIG. 6 (step 908).

If process 900 determines to act in the conduit mode (“Conduit mode” path of step 908), process 900 sends all available changes, including changes from the data processing system where process 900 may be executing, to the original server (step 910). Process 900 receives a synchronized document from the original server (step 912). Process 900 transmits the synchronized document to one or more data processing systems on the local network (step 914). Process 900 ends thereafter.

If, however, process 900 determines to act in the synchronizing mode (“Synchronize mode” path of step 908), process 900 synchronizes all available changes or changed documents using the baseline version of the document (step 916). Process 900 transmits the synchronized document to one or more data processing systems on the local network (step 918).

Process 900 may determine if network connectivity is available to the original server from the data processing system where process 900 may be executing (step 920). If connectivity to the original server is available (“Yes” path of step 920), process 900 may send a copy of the synchronized document to the original server (step 922). Process 900 ends thereafter. If no connectivity is available to the original server (“No” path of step 920), process 900 ends thereafter.

The components in the block diagrams and the steps in the flowcharts described above are described only as examples. The components and the steps have been selected for the clarity of the description and are not limiting on the illustrative embodiments. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the illustrative embodiments.

Thus, a computer implemented method, apparatus, and computer program product are provided in the illustrative embodiments for synchronizing documents by designating a local server. Using the illustrative embodiments, users can continue to synchronize or merge the variations in their local copy to a common baseline version of the document even when some or all users lose data network connectivity to a server that normally would perform the synchronization function.

When an original server is no longer reachable by some or all of the users' client data processing systems in a group of users, the client data processing systems may form a local network and designate one of the client data processing systems as a local server. The local server then performs the synchronization function and keeps all data processing systems on the local network in synchronization with respect to documents shared by the group. Thus, the illustrative embodiments allow groups of users to remain synchronized with each other without having to rely on outside resources or compromising security of the data processing systems or the documents.

The invention can take the form of an entirely hardware embodiment, an entirely software embodiment, or an embodiment containing both hardware and software elements. In a preferred embodiment, the invention is implemented in software, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for synchronizing documents by designating a local server, the computer implemented method comprising:
forming a data network, the data network including a plurality of data processing systems, each data processing system in the plurality of data processing systems having a separate version of a document;
designating a candidate data processing system from the plurality of data processing systems as a local server;
sending the separate versions of the document from the plurality of data processing systems to the local server;
synchronizing the separate versions of the document with a baseline version of the document to form a synchronized version of the document; and
returning the synchronized version of the document to the plurality of data processing systems.

2. The computer implemented method of claim 1, further comprising:
determining whether data connectivity to an original server has been lost; and
forming the data network responsive to the data connectivity to the original server being lost.

3. The computer implemented method of claim 1, further comprising:
sending the synchronized version of the document to an original server.

4. The computer implemented method of claim 1, wherein the candidate data processing system is selected based on server designation parameters, the server designation parameters including at least one of (i) a number of changes proposed by a data processing system, (ii) amount of computing resources available at a data processing system, (iii) bandwidth available at a data processing system, (iv) data connectivity available from a data processing system to an original server, and (v) a baseline version of a document, and wherein the designating is responsive to a server designation parameter being more favorable to the candidate data processing system as compared to another data processing system in the plurality of data processing systems.

5. The computer implemented method of claim 4, wherein one of (i) all, and (ii) less than all data processing systems in the plurality of data processing systems participate in selecting the candidate data processing system.

6. The computer implemented method of claim 1, further comprising:
determining that a subset of the plurality of data processing systems have lost data connectivity to an original server; and
selecting a data processing system from which data connectivity to the original server remains available as the candidate data processing system.

7. The computer implemented method of claim 6, further comprising:
determining that the local server is to act in a conduit mode; and
the synchronizing further comprising:
sending the separate versions of the document from the plurality of data processing systems to the original server; and
receiving the synchronized version of the document from the original server.

8. The computer implemented method of claim 1, further comprising:
sending a baseline version of a document to be synchronized from the local server to a data processing system in the plurality of the data processing systems that has a different version of the document.

9. A computer usable program product comprising a computer usable medium including computer usable code for synchronizing documents by designating a local server, the computer usable code comprising:
computer usable code for forming a data network, the data network including a plurality of data processing systems, each data processing system in the plurality of data processing systems having a separate version of a document;
computer usable code for designating a candidate data processing system from the plurality of data processing systems as a local server;
computer usable code for sending the separate versions of the document from the plurality of data processing systems to the local server;
computer usable code for synchronizing the separate versions of the document with a baseline version of the document to form a synchronized version of the document; and
computer usable code for returning the synchronized version of the document to the plurality of data processing systems.

10. The computer usable program product of claim 9, further comprising:
computer usable code for determining whether data connectivity to an original server has been lost;
computer usable code for forming the data network responsive to the data connectivity to the original server being lost; and
computer usable code for sending the synchronized version of the document to an original server.

11. The computer usable program product of claim 9,
wherein the candidate data processing system is selected based on server designation parameters, the server designation parameters including at least one of (i) a number of changes proposed by a data processing system, (ii) amount of computing resources available at a data processing system, (iii) bandwidth available at a data processing system, (iv) data connectivity available from a data processing system to an original server, and (v) a baseline version of a document,
wherein the computer usable code for designating operates responsive to a server designation parameter being more favorable to the candidate data processing system as compared to another data processing system in the plurality of data processing systems, and
wherein one of (i) all, and (ii) less than all data processing systems in the plurality of data processing systems participate in selecting the candidate data processing system.

12. The computer usable program product of claim 9, further comprising:
computer usable code for determining that a subset of the plurality of data processing systems have lost data connectivity to an original server; and
computer usable code for selecting a data processing system from which data connectivity to the original server remains available as the candidate data processing system.

13. The computer usable program product of claim 12, further comprising:
computer usable code for determining that the local server is to act in a conduit mode; and
the computer usable code for synchronizing further comprising:
computer usable code for sending the separate versions of the document from the plurality of data processing systems to the original server; and
computer usable code for receiving the synchronized version of the document from the original server.

14. The computer usable program product of claim 9, further comprising:
computer usable code for sending a baseline version of a document to be synchronized from the local server to a data processing system in the plurality of the data processing systems that has a different version of the document.

15. A data processing system for synchronizing documents by designating a local server, the data processing system comprising:
a storage device including a storage medium, wherein the storage device stores computer usable program code; and
a processor, wherein the processor executes the computer usable program code, and wherein the computer usable program code comprises:
computer usable code for forming a data network, the data network including a plurality of data processing systems, each data processing system in the plurality of data processing systems having a separate version of a document;
computer usable code for designating a candidate data processing system from the plurality of data processing systems as a local server;
computer usable code for sending the separate versions of the document from the plurality of data processing systems to the local server;
computer usable code for synchronizing the separate versions of the document with a baseline version of the document to form a synchronized version of the document; and
computer usable code for returning the synchronized version of the document to the plurality of data processing systems.

16. The data processing system of claim 15, further comprising:
computer usable code for determining whether data connectivity to an original server has been lost;
computer usable code for forming the data network responsive to the data connectivity to the original server being lost; and
computer usable code for sending the synchronized version of the document to an original server.

17. The data processing system of claim 15,
wherein the candidate data processing system is selected based on server designation parameters, the server designation parameters including at least one of (i) a number of changes proposed by a data processing system, (ii) amount of computing resources available at a data processing system, (iii) bandwidth available at a data processing system, (iv) data connectivity available from a data processing system to an original server, and (v) a baseline version of a document,
wherein the computer usable code for designating operates responsive to a server designation parameter being more favorable to the candidate data processing system as compared to another data processing system in the plurality of data processing systems, and
wherein one of (i) all, and (ii) less than all data processing systems in the plurality of data processing systems participate in selecting the candidate data processing system.

18. The data processing system of claim 15, further comprising:
computer usable code for determining that a subset of the plurality of data processing systems have lost data connectivity to an original server; and
computer usable code for selecting a data processing system from which data connectivity to the original server remains available as the candidate data processing system.

19. The data processing system of claim 18, further comprising:
computer usable code for determining that the local server is to act in a conduit mode; and
the computer usable code for synchronizing further comprising:
computer usable code for sending the separate versions of the document from the plurality of data processing systems to the original server; and
computer usable code for receiving the synchronized version of the document from the original server.

20. The data processing system of claim 15, further comprising:
computer usable code for sending a baseline version of a document to be synchronized from the local server to a data processing system in the plurality of the data processing systems that has a different version of the document.
